(19) United States
(12) Patent Application Publication
(10) Pub. No.: US 2013/0017913 A1
(43) Pub. Date: Jan. 17, 2013

(54) PRESSURE RELIEF VALVE IN A TENSIONING SYSTEM

(71) Applicant: Christian Hartmann, Nemsdorf (DE)

(72) Inventor: Christian Hartmann, Nemsdorf (DE)

(73) Assignee: Schaeffler Technologies AG & Co. KG, Herzogenaurach (DE)

(21) Appl. No.: 13/424,678

(22) Filed: Mar. 20, 2012

(30) Foreign Application Priority Data
Jul. 14, 2011 (DE) 102011079184.1

(51) Int. Cl. F16H 7/08

(52) U.S. Cl. 474/110

(57) ABSTRACT

A tensioning system for an internal combustion engine, including a traction mechanism, a rail on which the traction mechanism runs, and a hydraulic tensioning device, the tensioning device having a housing and a piston housing that is movable in the housing and to which pressure is applied by a spring, the housings delimiting a pressure chamber, and having a hydraulic medium supply and a check valve situated in the hydraulic medium supply, as well as a pressure relief valve situated in the piston housing for automatically opening at a pre-specified pressure in the pressure chamber, the pressure relief valve being a constructive unit that can be preassembled, having a valve housing, a valve cover, a valve body, and a valve spring, the valve housing and the valve cover being made of plastic.

### CROSS-REFERENCE TO RELATED APPLICATIONS

This application claims the benefit of German Patent Application No. 102011079184.1, filed Jul. 14, 2011, which is incorporated herein by reference as if fully set forth.

### FIELD OF THE INVENTION

The present invention relates to a tensioning system for an internal combustion engine, comprising a traction mechanism, a rail on which the traction mechanism runs, and a hydraulic tensioning device. The tensioning device has a housing and a piston housing that is movable in the housing and to which pressure is applied by a spring, which housings delimit a pressure chamber, as well as a hydraulic medium supply to the pressure chamber and a check valve situated in the hydraulic medium supply, as well as a pressure relief valve situated in the piston housing for automatic opening at a pre-specified pressure in the pressure chamber.

### BACKGROUND

A tensioning system of the type noted above is known from the utility model DE 94 09 155 U1. In this publication, a piston includes a bore in which there is situated a pressure relief valve, whose valve part is fashioned as a piston-type pressure piece and is axially movable in the bore and is in circumferential surface contact with the limiting walls of the bore. The valve part is pressed by a valve spring into sealing contact with two valve seat surfaces. The valve spring is supported on a sealing cover, and applies pressure to the end faces of the valve part, situated opposite one of the valve seat surfaces. The valve spring is housed in a space of the bore between the sealing cover and the valve part. A sleeve is set into this space that stands in circumferential contact with the limiting walls of the bore and is shorter in the axial direction than a distance between the valve part and the sealing cover. The upper side of the sleeve, facing the valve part, is fashioned as a stop surface for the movement of the valve part. Through a useful dimensioning of the axial length of the sleeve, in this way the path of the valve part, and thereby the maximum opening cross-section between the valve seat surfaces, can be predetermined. The function of the valve part can be tested only in the installed state, because the axial movement and the corresponding stroke defined by the sleeve constitute the functionality of the valve unit. This means that if there is a negative test result both the sealing cover and the sleeve, and thus the entire valve unit, must be disassembled.

### SUMMARY

The present invention provides a valve unit in a tensioning system, preferably a pressure relief valve, that can be installed in the tensioning system as a low-cost fully functional constructive unit.

According to an aspect of the present invention, the pressure relief valve is a constructive unit that can be pre-assembled, having a valve housing, a valve cover, a valve body, and a valve spring, the valve housing and the valve cover being made of plastic.

The particular advantage is that the functioning of the pressure relief valve can be tested before installation. Customarily, the pressure relief valve does not become capable of fully functioning until it is installed in the housing, and its proper functioning can also only be tested only after such installation. If flaws then appear, a time-consuming disassembly is then carried out. This expense of time and cost is rendered unnecessary by the pressure relief valve whose functional capacity is previously tested.

Describing the present invention in more detail, it is provided that the valve housing and the valve cover are connected to one another with a positive fit by a snap connection. The snap connection is realized by hooks that engage with one another, fashioned in the valve housing and in the valve cover. This realization is possible because the two components are made of plastic.

According to a further preferred development of the present invention, it is provided that the piston housing has a valve bore for accommodating the pressure relief valve, the diameter of the bore being smaller than that of the pressure relief valve. In this way, the pressure relief valve is held in the piston housing exclusively by a press fit. Additional components for holding it captive are then omitted.

According to a further preferred embodiment of the present invention, it is provided that the valve housing has an inlet port and an outlet port.

### BRIEF DESCRIPTION OF THE DRAWINGS

Exemplary embodiments of the present invention are shown in FIGS. 1-2, which are described in detail below, the present invention not being limited to these exemplary embodiments.

FIG. 1 is a cross-sectional view through a tensioning system; and

FIG. 2 is an enlarged cross-sectional view showing the pre-assembled pressure relief valve used in the tensioner of FIG. 1.

### DETAILED DESCRIPTION OF THE PREFERRED EMBODIMENTS

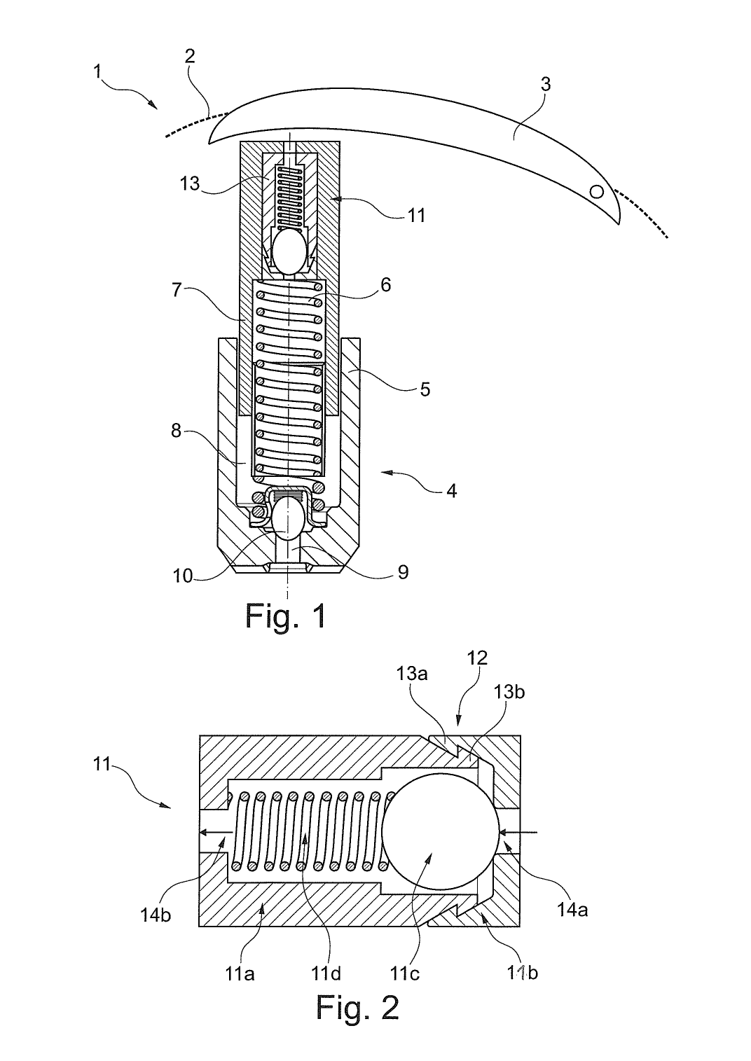

FIG. 1 shows the design of a tensioning system 1, comprising a traction mechanism 2, a rail 3 on which the traction mechanism 2 runs, and a hydraulic tensioning device 4 that presses against the rail 3 and thus re-tensions the extended traction mechanism 2. The tensioning device 4 as such has a housing 5 and a piston housing 7 that is movable in the housing 5 and to which pressure is applied by a spring 6. The housing 5 and the piston housing 7 delimit a pressure chamber 8. The pressure chamber 8 is equipped with a hydraulic medium supply channel 9 and a check valve 10 situated in the hydraulic medium supply channel 9. In the piston housing 7 there is provided a valve bore 13 in which a pressure relief valve 11 is situated. The pressure relief valve 11 is provided for automatic opening at a pre-specified pressure in pressure chamber 8.

FIG. 2 shows the pressure relief valve 11 separately. The pressure relief valve 11 according to the present invention comprises a cylindrical valve housing 11a having an outlet port 14b situated on its floor and a valve cover 11b having an inlet port 14a. Moreover, the pressure relief valve 11 has a valve spring 11d that applies pressure to a valve body 11c. The valve body 11c can be realized as a ball, as shown in FIG. 2, but a plate-type realization is also equally conceivable. An inlet port 14a forms a valve seat for the valve body 11c. The valve spring 11d is supported at one end on the floor inside the valve housing 11a, and with its other end it contacts the valve body 11c. Valve spring 11d ensures that the valve body 11c remains pressed into the valve seat up to a predefined pressure, in order to close inlet port 14a. the valve housing 11a has on its outer circumference, and the valve cover 11b has on its inner circumference, mutually corresponding hooks 13a, 13b. The valve housing 11a and the valve cover 11b, which are both made of plastic, enter into a snap connection 12 via the corresponding hooks 13a, 13b. Assembly is thus quick and economical, because it is necessary merely to place valve spring lid and valve body 11c into valve housing 11a and to snap in the pressed-on valve cover 11b.

### LIST OF REFERENCE CHARACTERS

1 tensioning system
2 traction mechanism
3 rail
4 tensioning device
5 housing
6 spring
7 piston housing
8 pressure chamber
9 hydraulic medium supply
10 check valve
11 pressure relief valve
11a valve housing
11b valve cover
11c valve body
11d valve spring
12 snap connection
13 valve bore
13a,b hooks
14a inlet port
14b outlet port

1. A tensioning system (1) for an internal combustion engine, comprising a traction mechanism (2), a rail (3) on which the traction mechanism (2) runs, and a hydraulic tensioning device (4), the tensioning device (4) having a housing (5) and a piston housing (7) that is movable in the housing (5) and to which pressure is applied by a spring (6), said housings limiting a pressure chamber (8), and a hydraulic medium supply (9) to the pressure chamber (8) and a check valve (10) situated in the hydraulic medium supply (9), as well as a pressure relief valve (11) situated in the piston housing (7) for the automatic opening at a pre-specified pressure in the pressure chamber (8), the pressure relief valve (11) is a pre-assembled unit having a valve housing (11a), a valve cover (11b), a valve body (11c), and a valve spring (11d), the valve housing (11a) and the valve cover (11b) being made of plastic.

2. The tensioning system as recited in claim 1, wherein the valve housing (11a) and the valve cover (11b) are connected to one another with a positive fit by a snap connection (12).

3. The tensioning system as recited in claim 2, wherein the snap connection (12) is created by hooks (13a, 13b) that are located on the valve housing (11a) and the valve cover (11b) and that engage with one another.

4. The tensioning system as recited in claim 1, wherein the piston housing (7) has a valve bore (13) for accommodating the pressure relief valve (11), a diameter of said bore being smaller than that of the pressure relief valve (11).

5. The tensioning system as recited in claim 1, wherein the pressure relief valve (11) is held in the piston housing (7) exclusively by a press fit.

6. The tensioning system as recited in claim 1, wherein the valve housing (11a) has an inlet port and an outlet port (14a, 14b).
